(19) United States
(12) Patent Application Publication
(10) Pub. No.: US 2005/0020107 A1
(43) Pub. Date: Jan. 27, 2005

(54) Card edge connector

(76) Inventor: Tung-Chang Lin, Taipei Hsien (TW)

Correspondence Address: MOLEX INCORPORATED, 2222 WELLINGTON COURT, LISLE, IL, 60532, US

(21) Appl. No.: 10/885,443

(22) Filed: Jul. 6, 2004

(30) Foreign Application Priority Data
Jul. 4, 2003 (TW) 92212385

(51) Int. Cl. H01R 13/648

(52) U.S. Cl. 439/78

(57) ABSTRACT

A card edge connector is used to receive an electrical card, and the electrical card can automatically withdraw from the card edge connector. The card edge connector comprises a main body, two arms, an insulative housing for receiving the electrical card, a plurality of terminals and an elastic element. The main body has a socket with a plurality of passageway. The terminals are received in corresponding internal grooves of the socket. The insulative housing further comprises a receiving hole communicated with the passageways. The elastic element is received in the receiving hole. When the electrical card is inserted into the socket of the card edge connector, the electrical card presses the elastic element, and the electrical card is withdrawn from the socket by elastic element.

### FIELD OF THE INVENTION

The present invention relates to a card edge connector, and especially to a card edge connector for receiving an electrical card, wherein the electrical card can automatically withdraw from the card edge connector

### BACKGROUND OF THE INVENTION

Referring to FIG. 1, the prior art provides a card edge connector used to receive an electrical card. The card edge connector comprises an insulative body 1 and a plurality of terminals (not shown in drawing). The insulative body 1 has a main body 11 and two side arms 12 formed at two sides of the main body 11. The main body 11 has a socket 111 for receiving an electrical card (not shown in drawing). The socket 111 has a plurality of terminal grooves 112 respectively arranged at one and another internal wall thereof for receiving a plurality of conductive terminals (not shown in drawing), respectively.

When a user wants to insert the electrical card into the card edge connector of prior art, first the electrical card with one side must be inserted (the electrical card in an inclined state) into one side of the socket 111, and second the electrical card with another side is pressed downward into another side of the socket 111 by a join point between one side of the electrical card and one side of the socket 111. At the same time, the two side arms 12 of the card edge connector are held open and sprung back correspondingly by two sides of the electrical card for firmly clamping the electrical card, so that the electrical card with a plurality of terminals are electrically connected to the conductive terminals of the card edge connector, respectively. In order to withdraw the electrical card from the socket 111, the two side arms 12 must be pushed outward. Then the electrical card is sprung in an inclined state by elastic force of the conductive terminals for the user drawing out the electrical card from the socket 111 easily.

However, when the electrical card is sprung in the inclined state, the electrical card with one side still is clamped in the corresponding conductive terminals. The card edge connector will scrape the contact pads of the electrical card, so that the electric conductivity may be compromised between the electrical card and the card edge connector.

### SUMMARY OF THE INVENTION

The primary object of the present invention is to provide a card edge connector. When an electrical card is inserted into the socket of the card edge connector, the electrical card presses an elastic element. When the electrical card is withdrawn from the socket, the elastic element prevents the contact pads of the electrical card from scraping.

In order to achieve the above objects, the present invention provides a card edge connector that comprises an insulative housing, a plurality of conductive terminals and an elastic element.

The insulative body has a main body and two side arms disposed at two sides of the main body, the main body having a socket and a receiving hole, the socket having a passageway formed thereon, and the receiving hole communicated with the passageway.

The conductive terminals are received in corresponding terminal grooves of the socket. And the elastic element is received in the receiving hole.

When the electrical card is inserted into the socket of the card edge connector, the electrical card presses the elastic element, and the electrical card is withdrawn from the socket by the elastic element.

### BRIEF DESCRIPTION OF DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a perspective view of the card edge connector of the prior art;

FIG. 2 is an exploded view of the card edge connector of the present invention;

FIG. 3 is a perspective view of the elastic element of the card edge connector in FIG. 2 of the present invention;

FIG. 4 is perspective view of the card edge connector of the present invention;

FIG. 5 is one schematic view of the card edge connector in using state according to the present invention;

FIG. 6 is second schematic view of the card edge connector in using state according to the present invention;

FIG. 7 is third schematic view of the card edge connector in using state according to the present invention;

FIG. 8 is exploded view of rear view of the card edge connector according to another embodiment of the present invention;

FIG. 9 is perspective view of front view of the card edge connector according to another embodiment of the present invention; and

FIG. 10 is schematic view of side view according to another embodiment of the present invention, when the electrical card inserted into the card edge connector.

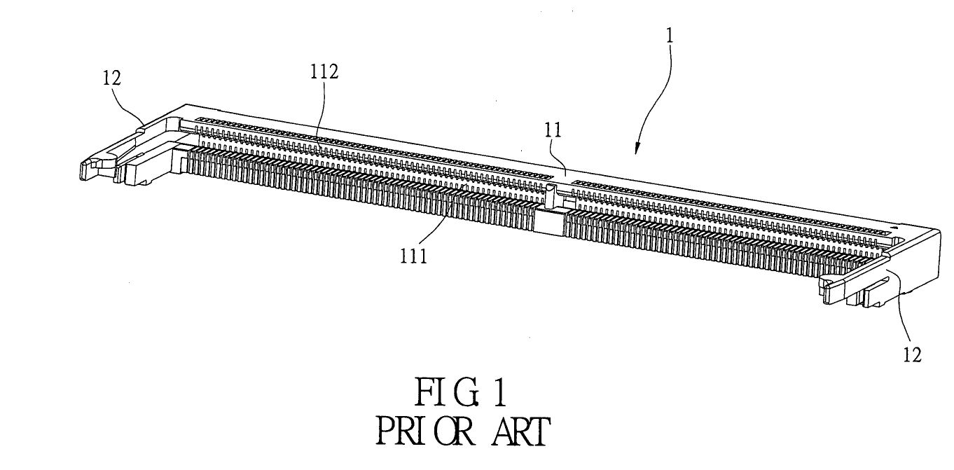

### DETAILED DESCRIPTION OF THE DISCLOSED EMBODIMENTS

While the invention may be susceptible to embodiment in different forms, there is shown in the drawings, and herein will be described in detail, a specific embodiment with the understanding that the present disclosure is to be considered an exemplification of the principles of the invention, and is not intended to limit the invention to that as illustrated and described herein.

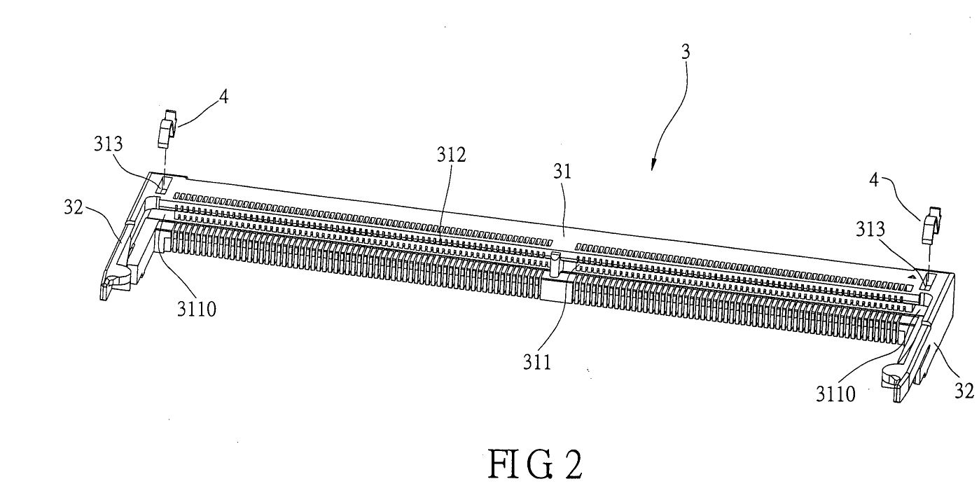

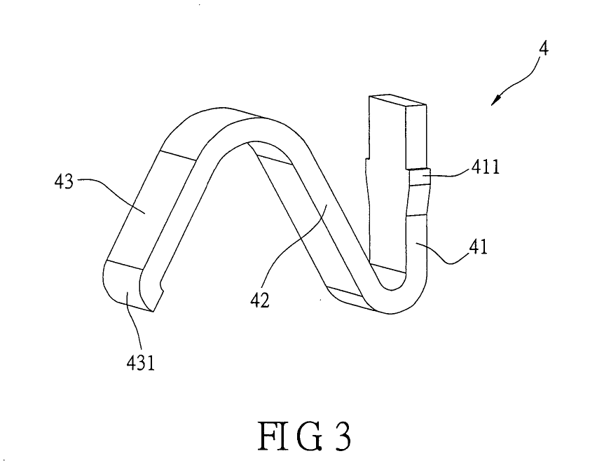

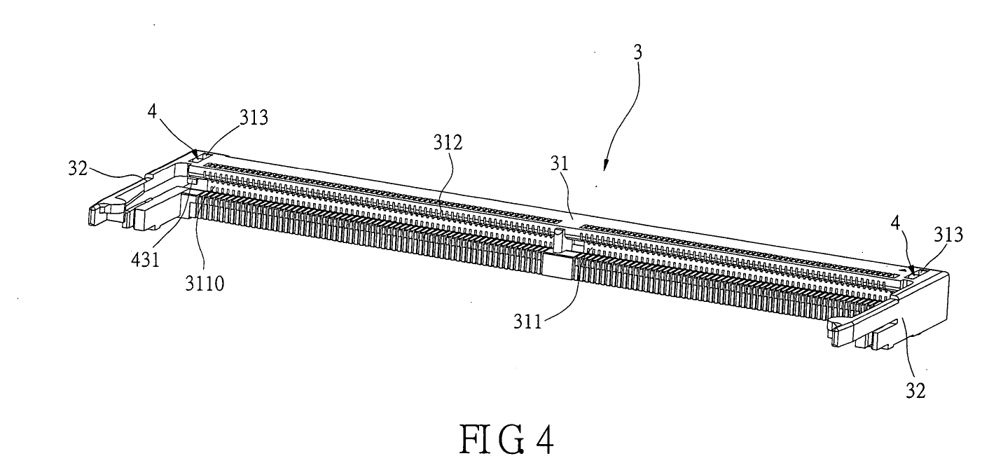

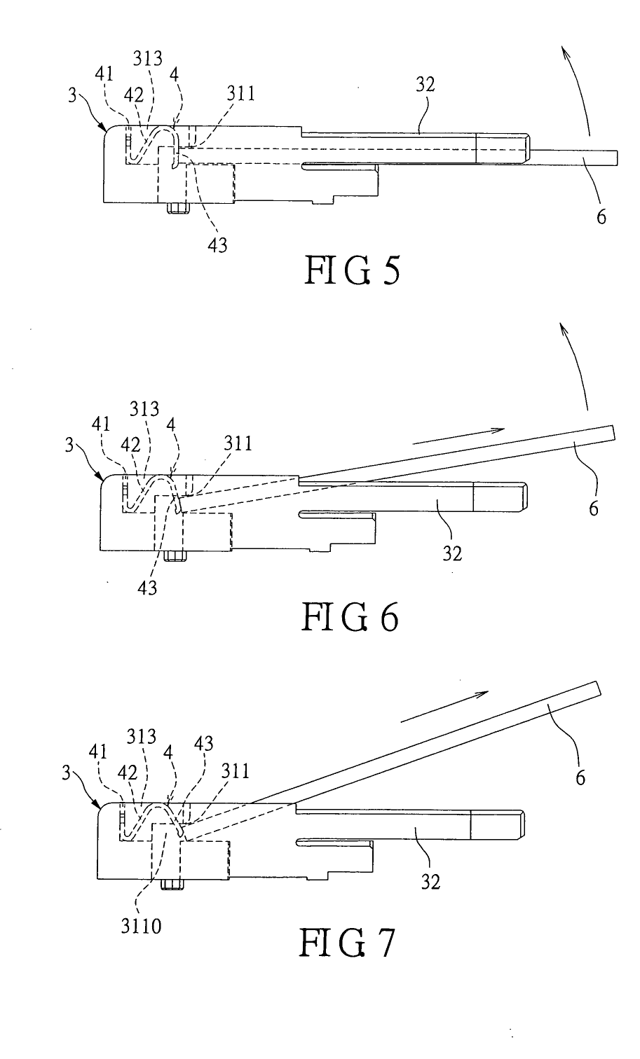

Referring to FIGS. 2 to 4, the present invention provides a card edge connector, which comprises an insulative body 3, an elastic element 4 and a plurality of conductive terminals (not shown in drawing). The insulative body 3 has a main body 31 and two side arms 32 disposed at two sides of the main body 31. The main body 31 has a socket 311 disposed at front side thereof for receiving an electrical card 6 (shown as FIGS. 5 to 7). The socket 311 has a plurality of terminal grooves 312 for receiving the corresponding conductive terminals.

The socket 311 has two passageways 3110 formed at two sides thereof, respectively. The main body 31 has two receiving holes 313 formed at a top side of two sides thereof, respectively. The two receiving holes 313 are communicated with the corresponding passageways 3110.

The elastic element 4 comprises a fixed portion 41, an extended portion 42 bended obliquely upwardly from one side of the fixed portion 41 and an elastic arm 43 bended obliquely downward from one side of the extended portion 42. The fixed portion 41 has a plurality of interference portions 411. The elastic arm 43 with another side has a guiding edge 431.

Referring to FIG. 2, 3 and 7, the elastic element 4 is received in the receiving hole 313 of the insulative housing 3. The elastic element 4 is fixed in the receiving hole 313 by the fixed portion 41. The interference portions 411 are used to firmly fix the fixed portion 41 in the receiving hole 313. Both the extended arm 42 and the elastic arm 43 are inserted into the passageway 3110.

Referring to FIGS. 5 to 7, when the electrical card 6 is inserted in the socket 311 of the card edge connector, the elastic element 4 is pressed by the electrical card 6. When the user push aside the two side arms 32, the electrical card 6 is sprung in an inclined state and withdrew from the socket 311 without manpower for preventing the contact pads of the electrical card from scraping.

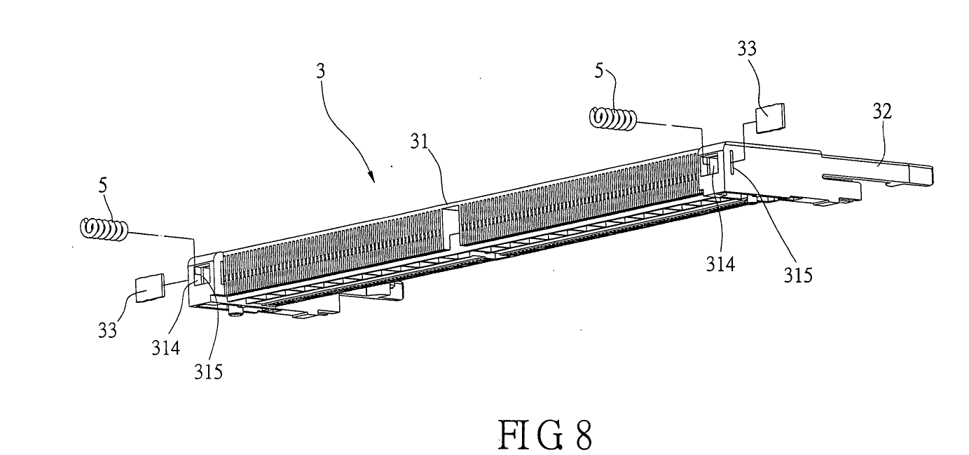

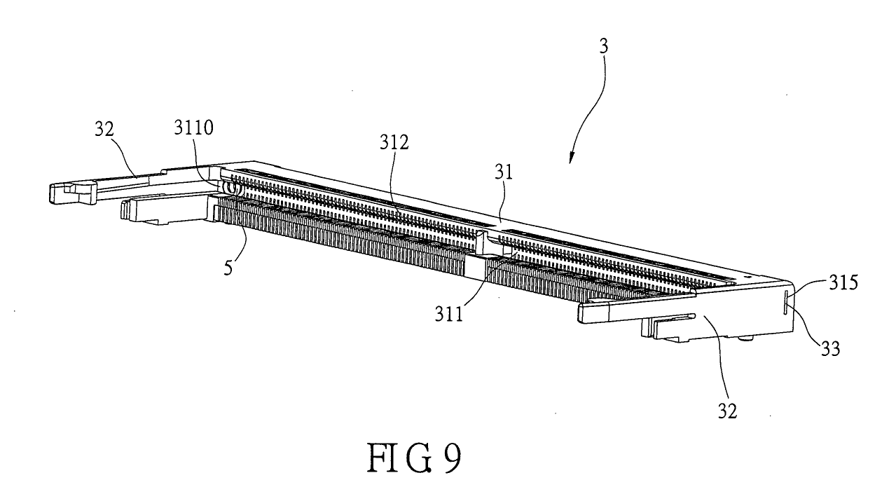

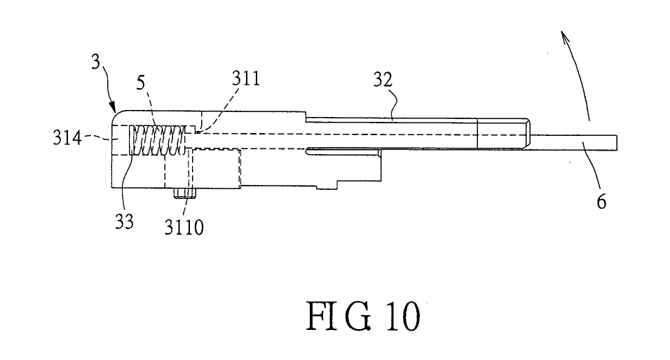

Referring to FIGS. 8 to 10, the receiving hole 314 is disposed at a rear side of the two sides of the main body 31. The receiving hole 314 and the passageway 3110 are communicated to each other and arranged in the same straight line for receiving the elastic element 5 (the elastic element 5 is a linear spring). The elastic element 5 is received between a front side of the passageway 3110 and a rear side of the receiving hole 314. The main body 3 further comprises a side slot 315. The side slot 315 has a stop piece 33 inserted therein and disposed at the rear side of the receiving hole 314 for positioning the elastic element 5 between the front side of the passageway 3110 and the stop piece 33. When the electrical card is inserted into the socket of the card edge connector, the electrical card presses the elastic element, and the electrical card is withdrawn from the socket by the elastic element.

Although the present invention has been described with reference to the disclosed embodiments thereof, it will be understood that the invention is not limited to the details thereof. Various substitutions and modification have suggested in the foregoing description, and it is envisioned that those skilled in the art may devise various modifications of the present invention without departing from the spirit and scope of the appended claims.

1. A card edge connector comprising:
an insulative body having a main body and two side arms disposed at two sides of the main body, the main body having a socket and a receiving hole, the socket having a passageway formed thereon, and the receiving hole communicated with the passageway;
a plurality of conductive terminals received in corresponding terminal grooves of the socket;
an elastic element received in the receiving hole;
wherein, when the electrical card is inserted into the socket of the card edge connector, the electrical card presses the elastic element, and the electrical card is withdrawn from the socket by the elastic element.

2. The card edge connector as claimed in claim 1, wherein the elastic element is a spring.

3. The card edge connector as claimed in claim 1, wherein the elastic element comprises a fixed portion, an extended portion bended obliquely upwardly from one side of the fixed portion and an elastic arm bended obliquely downward from one side of the extended portion.

4. The card edge connector as claimed in claim 3, wherein the receiving hole is formed on a top side of the main body, the fixed portion of the elastic element is fixed in the receiving hole, both the extended arm and the elastic arm being inserted into the passageway.

5. The card edge connector as claimed in claim 3, wherein the fixed portion comprises a plurality of interference portions for firmly fixing the fixed portion in the receiving hole.

6. The card edge connector as claimed in claim 3, wherein the elastic arm has a guiding edge.

7. The card edge connector as claimed in claim 1, wherein the elastic element is a linear spring.

8. The card edge connector as claimed in claim 7, wherein the receiving hole is formed on a rear side of the main body, both the receiving hole and the passageway arranged at same straight line, the elastic element received between a front side of the passageway and a rear side of the receiving hole.

9. The card edge connector as claimed in claim 8, wherein the main body comprises a side slot, the side slot having a stop piece inserted therein and disposed at the rear side of the receiving hole for positioning the elastic element between the front side of the passageway and the stop piece.
